(19) United States
(12) Patent Application Publication
(10) Pub. No.: US 2018/0182075 A1
(43) Pub. Date: Jun. 28, 2018

(54) IMAGE PROCESSING APPARATUS, IMAGE CAPTURING APPARATUS, METHOD OF IMAGE PROCESSING, AND STORAGE MEDIUM

(71) Applicant: CANON KABUSHIKI KAISHA, Tokyo (JP)

(72) Inventor: Takao Sasaki, Yokohama-shi (JP)

(21) Appl. No.: 15/844,031

(22) Filed: Dec. 15, 2017

(30) Foreign Application Priority Data
Dec. 22, 2016 (JP) 2016-249803

(51) Int. Cl. G06T 5/00

(52) U.S. Cl. CPC G06T 5/003; G06T 2207/20208; G06T 5/009

(57) ABSTRACT

Image processing apparatuses, methods of image processing and storage mediums for use therewith are provided herein. At least one image processing apparatus includes a calculation unit configured to calculate a coefficient of image magnification correction for correcting a difference in image magnification due to a difference in an in-focus position with respect to a plurality of images having different in-focus positions; and a correction unit configured to perform brightness correction on at least some of a plurality of images. The correction unit sets, for each of the plurality of images, a brightness detection area of a size corresponding to the coefficient of the image magnification correction, and performs the brightness correction based on a brightness value acquired in the brightness detection area set for each of the images.

### BACKGROUND OF THE INVENTION

### Field of the Invention

The present disclosure relates to display performed by at least one embodiment of an image processing apparatus and, more particularly, to at least one embodiment of an image processing apparatus which composites images having different in-focus positions.

### Description of the Related Art

When capturing images of a plurality of objects at different distances from an image capturing apparatus, such as a digital camera, or capturing an image of an object which extends away from the capturing apparatus, only a part of the object may be in focus because the depth of field of an image capturing optical system is not sufficient. In order to solve this issue, Japanese Patent Laid-Open No. 2015-216532 discloses a technique of capturing a plurality of images while changing in-focus positions, extracting an in-focus area from each image and compositing the in-focus areas into a single image, and generating a composite image in which the entire image capturing region is in focus (hereinafter, this technique is referred to as “focus stacking”).

When compositing a plurality of images, brightness values of an object included in these images need to coincide with one another. If the images can be captured using a certain light source, a plurality of images may be captured with a fixed exposure value. However, if the images are to be captured outdoors, since external light is not consistent in many cases, it is necessary to capture a plurality of images having different in-focus positions while performing exposure control.

However, since a plurality of acquired images having different in-focus positions may have different image magnification, the brightness values of the object included in the images will not necessarily coincide only in response to exposure control. This is because, when image magnification changes, a change is caused in a ratio of the size of the object included in each image to the size of the area used for the calculation of the brightness value, and the object included in the area used for the calculation of the brightness value changes for every image.

### SUMMARY OF THE INVENTION

The present disclosure provides at least one embodiment of an image processing apparatus capable of, when compositing a plurality of images having different in-focus positions, suppressing a difference of brightness values in the same object area among a plurality of images.

At least one embodiment of the present disclosure is an image processing apparatus which includes a calculation unit configured to calculate a coefficient of image magnification correction for correcting a difference in image magnification due to a difference in an in-focus position with respect to a plurality of images having different in-focus positions, and a correction unit configured to perform brightness correction on at least some of the plurality of images. The correction unit sets, for each of the plurality of images, a brightness detection area of a size corresponding to the coefficient of the image magnification correction, and performs the brightness correction based on a brightness value acquired in the brightness detection area set for each of the images.

According to other aspects of the present disclosure, one or more additional image processing apparatuses, one or more methods of image processing and one or more recording or storage mediums for use therewith are discussed herein. Further features of the present disclosure will become apparent from the following description of exemplary embodiments with reference to the attached drawings.

### BRIEF DESCRIPTION OF THE DRAWINGS

FIG. 1 is a block diagram illustrating a structure of a digital camera according to at least a first embodiment.

FIG. 2 is a flowchart illustrating at least the first embodiment.

FIG. 3 illustrates determination of a brightness detection area in at least the first embodiment.

FIG. 4A illustrates image magnification correction when an area in which a brightness change is small in at least the first embodiment is set to be a brightness detection area, and FIG. 4B illustrates image magnification correction when the entire image in at least the first embodiment is set to be a brightness detection area.

FIG. 5 illustrates calculation of a brightness difference when an edge exists in the brightness detection area in at least the first embodiment.

FIG. 6 is a flowchart illustrating at least a second embodiment.

FIG. 7 illustrates a positional relationship between an area to be discarded and a brightness detection area in at least the second embodiment.

### DESCRIPTION OF THE EMBODIMENTS

Hereinafter, embodiments of the present disclosure will be described in detail with reference to the appended drawings.

### First Embodiment

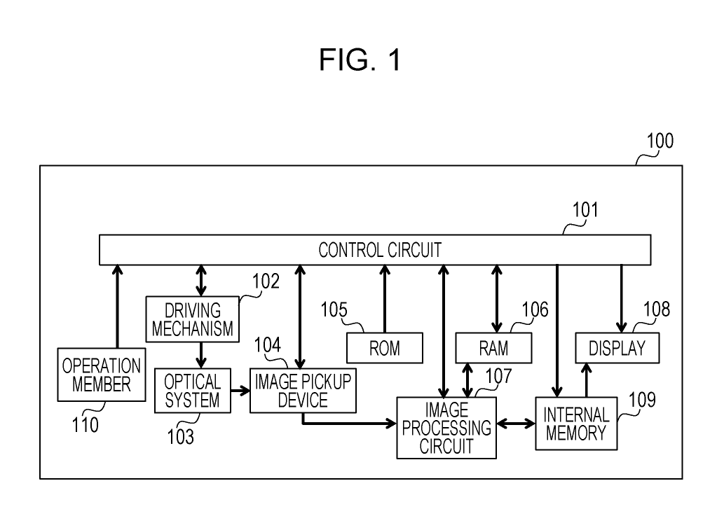

FIG. 1 is a block diagram illustrating a structure of a digital camera according to the present embodiment.

A control circuit 101 is a signal processor, such as a CPU and an MPU, for example, which loads a program stored in advance in later-described ROM 105 and controls each section of a digital camera 100. For example, as described later, the control circuit 101 provides a later-described image capturing element 104 with instructions for starting and ending image capturing. The control circuit 101 also provides a later-described image processing circuit 107 with an instruction for image processing in accordance with the program stored in the ROM 105. Instructions by a user are input into the digital camera 100 by a later-described operation member 110, and reach each section of the digital camera 100 via the control circuit 101.

A driving mechanism 102 is constituted by, for example, a motor and operates a later-described optical system 103 in a mechanical manner under the instruction of the control circuit 101. For example, in accordance with an instruction of the control circuit 101, the driving mechanism 102 moves a focusing lens included in the optical system 103 and adjusts a focal length of the optical system 103.

The optical system 103 includes a zoom lens, a focusing lens, and a diaphragm. The diaphragm is a mechanism for adjusting an amount of light to penetrate. By changing the position of the focusing lens, an in-focus position can be changed.

The image capturing element 104 is a photoelectric conversion device which photoelectrically converts incident optical signals into electrical signals. The image capturing element 104 may be a CCD or a CMOS sensor, for example.

The ROM 105 is a nonvolatile read-only memory as a recording medium which stores an operation program for each block included in the digital camera 100, parameters necessary for the operation of each block, etc. RAM 106 is volatile rewritable memory used as a temporary storage area of data output in an operation of each block provided in the digital camera 100.

The image processing circuit 107 performs various types of image processing, such as white balance adjustment, color interpolation, and filtering, to an image output from the image capturing element 104, or data of image signals recorded in later-described internal memory 109. The image processing circuit 107 also performs data compression on the data of image signals captured by the image capturing element 104 in the JPEG format, for example.

The image processing circuit 107 is constituted by an integrated circuit in which circuits which perform specific processings are collected (ASIC). Alternatively, the control circuit 101 may perform a part or all of the functions of the image processing circuit 107. In that case, control circuit 101 performs processing in accordance with a program loaded from the ROM 105. If the control circuit 101 performs all of the functions of the image processing circuit 107, the image processing circuit 107 as hardware can be excluded.

A display 108 is a liquid crystal display, an organic EL display, etc. for displaying an image temporarily stored in the RAM 106, an image stored in the later-described internal memory 109, or a settings screen of the digital camera 100. The display 108 reflects an image acquired by the image capturing element 104 as a display image in real time (“live view display”).

In the internal memory 109, an image captured by the image capturing element 104, an image processed by the image processing circuit 107, information on the in-focus position during image capturing, etc. are recorded. A memory card etc. may be used instead of the internal memory.

An operation member 110 is, for example, a button, a switch, a key, a mode dial, etc. attached to the digital camera 100, or a touch panel used also as the display 108. An instruction input by the user by using the operation member 110 reaches the control circuit 101, and the control circuit 101 controls an operation of each block in accordance with the instruction.

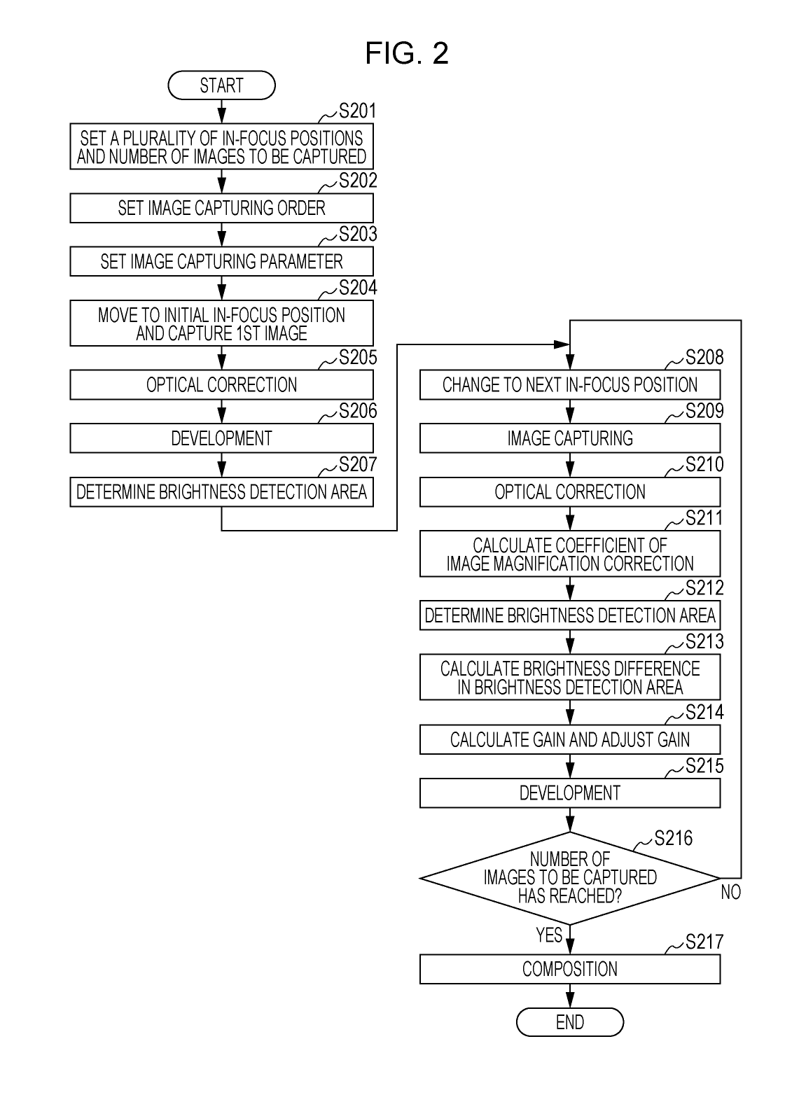

FIG. 2 is a flowchart illustrating the present embodiment.

In step S201, the control circuit 101 sets a plurality of in-focus positions and the number of images to be captured. For example, a user sets an in-focus area via a touch panel, and the optical system 103 measures an in-focus position corresponding to the in-focus area. The control circuit 101 sets predetermined numbers of in-focus positions in front of and behind the measured in-focus position. The control circuit 101 desirably sets distances between adjacent in-focus positions so that ends of depth of field may overlap slightly.

In step S202, the control circuit 101 sets an image capturing order. Generally, a function of a relationship between an in-focus position and image magnification is uniquely determined depending on the type of the lens, and the function monotonously changes. Here, in accordance with the function of the relationship between the in-focus position and the image magnification stored in advance, the control circuit 101 sets the image capturing order in a manner such that the image magnification will become smaller as the images are sequentially captured. For example, if the function between the image magnification and the in-focus position is a monotonic decrease, the control circuit 101 sets an image capturing order so that the image magnification will become smaller as the in-focus position separates from the initial in-focus position with the closest in-focus position being defined as an initial in-focus position. On the other hand, if the function between the image magnification and the in-focus position is a monotonic increase, the control circuit 101 sets the image capturing order so that the image magnification will become smaller from the most distant in-focus position. In this manner, a field angle of an initially captured image is the narrowest and the field angle will become larger as image capturing is repeated. Therefore, unless both the camera and an object have moved, an object area included in a previously captured image is reliably included in the field angle of an image captured subsequently.

In step S203, the control circuit 101 starts setting of an image capturing parameter. Here, “image capturing parameter” refers to a shutter speed and ISO sensitivity, for example, based on subject brightness. The image capturing element 104 periodically repeats image capturing in order to display a live view image and, in step S203 and subsequent steps, the control circuit 101 repeats automatic exposure control based on the subject brightness acquired from the image captured as the live view image.

In step S204, the optical system 103 moves to the initial in-focus position set in step S203, and the image capturing element 104 captures a first image used for composition.

In step S205, the image processing circuit 107 performs optical correction. Here, “optical correction” refers to correction completed in a single captured image, and may be peripheral light amount correction, chromatic aberration correction, distortion aberration correction, for example.

In step S206, the image processing circuit 107 performs development. “Development” refers to convert a RAW image into YCbCr image data that can be encoded in the JPEG format, and to perform correction, such as edge correction and noise reduction.

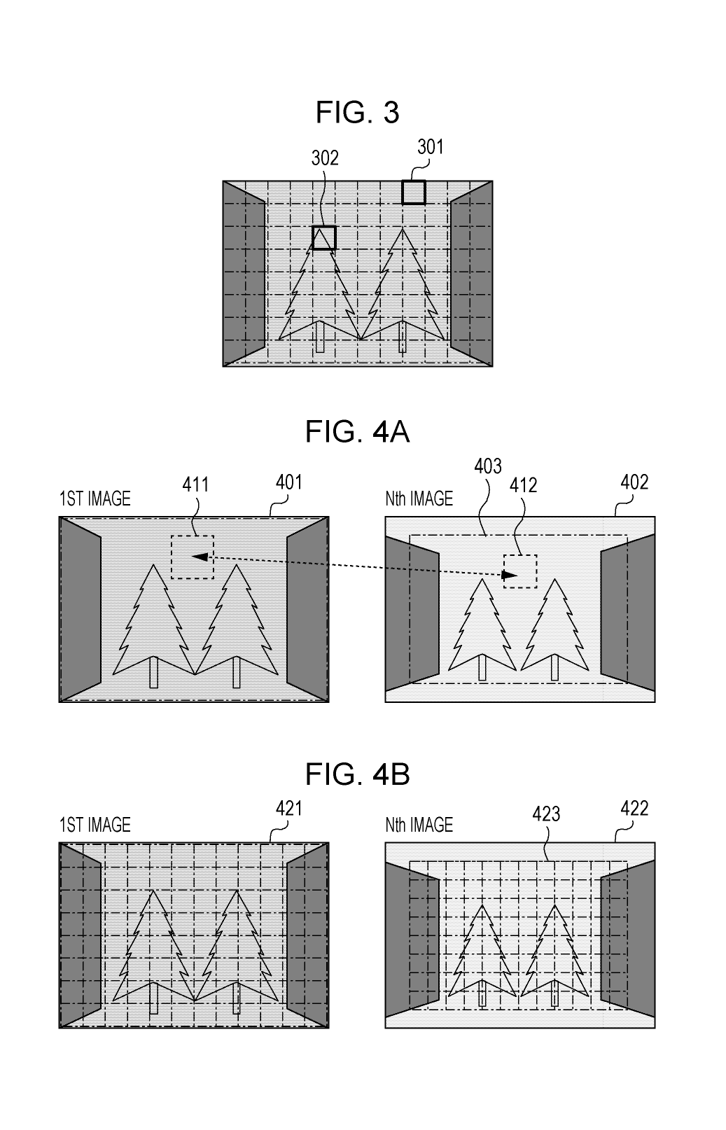

In step S207, the image processing circuit 107 determines a brightness detection area. The brightness detection area may be an arbitrary area in the image, however, the brightness detection area may desirably be an area in which a brightness change is small. The reason therefor is as follows. When a user captures images by holding a camera in hand not using a tripod, the position of the camera may change slightly every time the user captures an image. Therefore, if an area in which the brightness change is small is defined as the brightness detection area, even if the position of the brightness detection area with respect to an object area is shifted slightly by camera shake, an influence of the shift can be suppressed. FIG. 3 illustrates determination of the brightness detection area in the present embodiment. In FIG. 3, since a change in brightness in an area 301 with a smaller amount of edge is smaller than a change in brightness in an area 302 with a longer edge, an image processing circuit 307 desirably determines the area 301 to be a brightness detection area.

In step S208, in accordance with the image capturing order set in step S202, the optical system 103 changes the in-focus position into a subsequent in-focus position from the in-focus position in which image is captured immediately before, among a plurality of in-focus positions set in step S201.

In step S209, the image capturing element 108 captures a second image and subsequent images used for composition.

In step S210, the image processing circuit 107 performs optical correction on the images captured by the image capturing element 108 in step S209. Here, “optical correction” is the same processing as in step S205.

In step S211, the image processing circuit 107 calculates a coefficient of image magnification correction with respect to the second image and subsequent images so that the size of the object areas included in a plurality of images coincide with one another based on the function of the relationship between the in-focus position and the image magnification stored in advance. FIGS. 4A and 4B illustrate image magnification correction in the present embodiment. Since the control circuit 101 has set the image capturing order in a manner such that the image magnification will become smaller in step S202, image magnification of the first image will become larger than image magnification of an Nth image. FIG. 4A illustrates that an area corresponding to an area 403 of an Nth image 402 corresponds to the entire area 401 of a first image 401. Magnification necessary to enlarge the area 403 to the size of the entire area 401 is calculated as a coefficient of image magnification correction.

In step S212, the image processing circuit 107 calculates the brightness detection area corresponding to the brightness detection area determined in step S207 in the image captured in step S209. The calculated brightness detection area is an area 412 in FIG. 4A, for example. A method for determining the area 412 will be described hereinafter. First, regarding an area 411 which is the brightness detection area in the image 401, the image processing circuit 107 loads a distance from the center position of the image 401 to the center position of the area 411, and the size of the area 411. Next, the image processing circuit 107 corrects the distance from the center position of the image 401 to the center position of the area 411 and the size of the area 411 by using the coefficient of the image magnification correction calculated in step S211, and determines the center position and the size of the brightness detection area 412.

Here, the image processing circuit 107 sets the area in which a brightness change is small in the image 401 to be the brightness detection area 411, however, as illustrated in FIG. 4B, the entire first image 421 may be set to be the brightness detection area. In this case, an area 423 which is an area corresponding to the total field angle of the image 421 is set to be the brightness detection area in an image 422.

In step S213, the image processing circuit 107 calculates a brightness difference between the brightness detection areas set in the images. The brightness difference may be calculated by a plurality of methods. One of the methods may be simply calculating an integral value of the brightness of the brightness detection area and calculating the brightness difference using the calculated integral value. This method is desirable when an area having no edge (e.g., the area 301 of FIG. 3) is set to be the brightness detection area. Another method is applying a blurring filter which causes a blurring amount greater than an out-of-focus amount due to a difference in the in-focus positions of the two images to each image, and then calculating a brightness difference of the brightness detection areas. Since a brightness calculation difference caused by the out-of-focus amount due to the difference in the in-focus positions can be reduced, this method is effective in an object with a larger amount of edge.

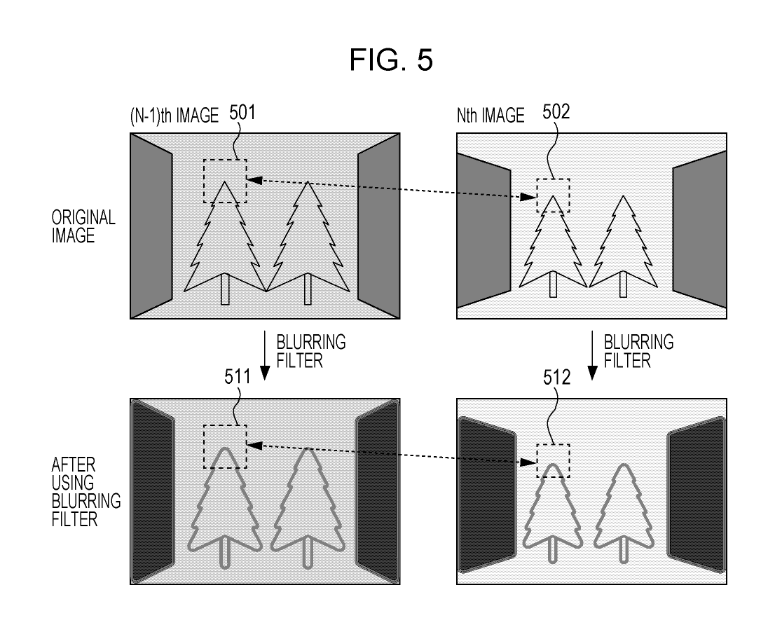

FIG. 5 illustrates calculation of a brightness difference when a larger amount of edge is included in the set brightness detection area. Since there is an edge in each of a brightness detection area 501 and a brightness detection area 502, the brightness difference between the brightness detection area 501 and the brightness detection area 502 of original images before applying the blurring filters is not calculated but the brightness difference between a brightness detection area 511 and a brightness detection area 512 of the images after applying the blurring filters is calculated.

In step S214, the image processing circuit 107 calculates a gain for correcting the brightness difference calculated in step S212, applies the calculated gain to the images acquired in step S209, and implements brightness correction.

In step S215, the image processing circuit 107 develops the images which have been subjected to brightness correction.

In step S216, the control circuit 101 determines whether the number of images to be captured set in step S201 has been captured. If the number of images to be captured set in step S201 has been captured, the process proceeds to step S217, and the image processing circuit 107 composites the captured images. If the number of images to be captured set in step S201 has not been captured, the process returns to step S208, and the in-focus position is changed and image capturing is continued.

In step S217, the image processing circuit 107 performs image magnification correction and composition. An example of the composition method will be described briefly hereinafter. First, the image processing circuit 107 performs image magnification correction using the coefficient of image magnification correction calculated in step S211 and, for example, captures and enlarges the area 403 from the image 402 of FIG. 4A. Then, the image processing circuit 107 obtains the sum of absolute difference (SAD) of a difference in the output of pixels of the plurality of images, while shifting the relative positions of the two images for alignment. Relative moving amounts and moving directions of the two images when the SAD value becomes the smallest are obtained. After calculating a transformation coefficient of the affine transformation or projective transformation in accordance with the obtained moving amounts and the obtained moving directions, the image processing circuit 107 optimizes the transformation coefficient by using the least square method so that a difference between the moving amount by the transformation coefficient and the moving amount calculated from the SAD will become the smallest. Based on the optimized transformation coefficient, the image processing circuit 107 performs a transformation process on the images to be aligned.

Then, the image processing circuit 107 produces a composition MAP by using a contrast value obtained from the images after alignment. In particular, in each noticed area or noticed pixel in the images after alignment, the composition ratio of the image with the highest contrast ratio is defined as 100% and the composition ratio of the rest of the images is defined as 0%. When the composition ratio changes from 0% to 100% (or from 100% to 0%) between adjacent pixels, unnaturalness in a composition boundary will become apparent. Therefore, by applying a low-pass filter having predetermined number of pixels (tap numbers) to the composition MAP, the composition MAP is processed so that the composition ratio does not change suddenly between adjacent pixels. Further, based on the contrast value of each image in the noticed area or the noticed pixel, a composition MAP in which the composition ratio will become higher as the contrast value of the image becomes higher may be produced. By performing alignment after the image processing circuit 107 performs brightness combination, alignment accuracy is improved.

The above description is an example to implement the present embodiment, and may be changed variously. For example, optical correction may be performed after the development of the image, not before the development of the image.

In the above description, all of the image magnification correction, the calculation of the brightness difference, and the calculation of the gain are performed based on the difference between the first image and the Nth image. However, these correction and calculation may be performed based on a difference between the (N−1)th image captured immediately before and the Nth image.

According to the first embodiment, by comparing the brightness differences in the brightness detection areas of the captured images, an influence of the brightness differences due to the change in the field angle on the calculation can be avoided. Further, the brightness differences can be effectively reduced also in a plurality of images with different field angles in focus stacking.

It is also possible to perform brightness correction described in step S214 after performing image magnification correction and alignment described in step S217. However, alignment can be performed with high accuracy if brightness correction is performed before performing alignment and the difference in the subject brightness with respect to the identical object area is suppressed.

As described above, according to the present embodiment, the brightness values among a plurality of images can be corrected in consideration of the difference in image magnification among a plurality of images having different in-focus positions. Therefore, occurrence of brightness unevenness when the plurality of images is composited can be suppressed.

### Second Embodiment

In a second embodiment, unlike the first embodiment, a plurality of images used for composition can be captured while a user changes an in-focus position into arbitrary positions. Hereinafter, the second embodiment will be described mainly about differences from the first embodiment. The same configurations as those of the first embodiment are not described.

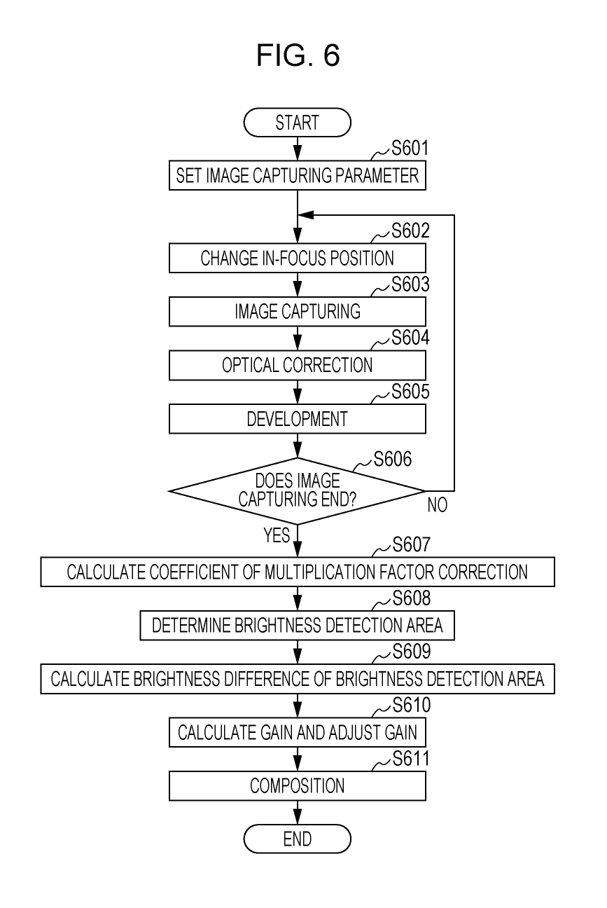

FIG. 6 is a flowchart illustrating the second embodiment.

In step S601, a control circuit 101 sets image capturing parameters as in step S203 of the first embodiment. In particular, the control circuit 101 repeats automatic exposure control based on the subject brightness acquired from the image captured as the live view image.

In step S602, the control circuit 101 moves the in-focus position in accordance with an operation amount of a focus ring by a user.

In step S603, an image capturing element 104 captures an image used for composition upon full-depression of a shutter button by the user.

In step S604, an image processing circuit 107 performs optical correction as in step S205 of the first embodiment.

In step S605, the image processing circuit 107 performs development as in step S206 of the first embodiment.

In step S606, the control circuit 101 determines whether an operation representing an end of image capturing is performed by the user. If the focus ring is operated by the user without performing this operation, the process returns to step S602. Alternatively, if the number of images to be captured is set in advance before step S601, whether this number of images to be captured has been captured may be determined.

In step S607, the image processing circuit 107 calculates a coefficient of image magnification correction based on a function of a relationship between the in-focus position and image magnification stored in advance with respect to all the images captured in step S603. First, image magnifications of all the images which the image capturing element 104 captured in step S603 are compared, and the image with largest image magnification among the images is acquired as a reference image. Next, the image processing circuit 107 compares image magnification of the rest of the images with image magnification of the reference image and calculates a coefficient of image magnification correction.

In step S608, a brightness detection area is set in the reference image in the same manner as described in step S207, and a brightness detection area is set also in each of other images in the same manner as described in step S212, based on the coefficient of the calculated image magnification correction.

In step S609, the image processing circuit 107 calculates a brightness difference between the brightness detection areas set in the images as in step S213 of the first embodiment.

In step S610, the image processing circuit 107 calculates a gain and adjusts the gain for correcting the brightness difference as in step S214 of the first embodiment.

In step S611, the image processing circuit 107 performs image magnification correction and composition as in step S217 of the first embodiment.

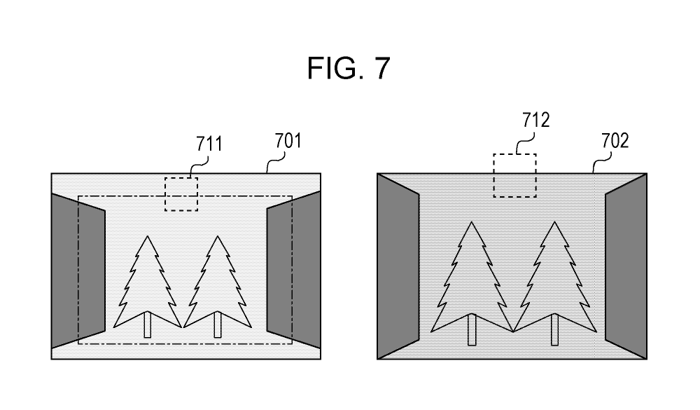

Here, the reason that the image having the largest image magnification is defined as a reference image in step S607, and that a brightness detection area is set in the reference image in step S608 will be described. FIG. 7 illustrates a positional relationship between an area to be discarded by image magnification correction and a brightness detection area in the present embodiment. An image 701 and an image 702 are different in-focus positions. The image 702 is greater in image magnification than the image 701. If the image processing circuit 107 first sets a brightness detection area 711 in the image 701, an area equivalent to the brightness detection area in the image 702 will become an area 712. However, since the area 712 includes outside of the field angle of the image 702, the image processing circuit 107 cannot accurately detect brightness by using the area 712. Therefore, the image processing circuit 107 needs to set an image having the largest image magnification as a reference image.

As described above, according to the second embodiment, the brightness value between images can be corrected in consideration of the difference in image magnification between a plurality of images having different in-focus positions, even if an image capturing order based on a focus value is not set.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-Ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-249803 filed Dec. 22, 2016, which is hereby incorporated by reference herein in its entirety.

What is claimed is:

1. An image processing apparatus, comprising:
a calculation unit configured to calculate a coefficient of image magnification correction for correcting a difference in image magnification due to a difference in an in-focus position with respect to a plurality of images having different in-focus positions; and
a correction unit configured to perform brightness correction on at least some of the plurality of images, wherein
the correction unit sets, for each of the plurality of images, a brightness detection area of a size corresponding to the coefficient of the image magnification correction, and performs the brightness correction based on a brightness value acquired in the brightness detection area set for each of the images.

2. The image processing apparatus according to claim 1, wherein
the calculation unit sets one of the plurality of images to be a reference image and calculates a coefficient of the image magnification correction based on a ratio of image magnification of other images to image magnification of the reference image.

3. The image processing apparatus according to claim 2, wherein
the reference image is an image having the largest image magnification among the plurality of images.

4. The image processing apparatus according to claim 2, wherein
the correction unit determines the brightness detection area in the reference image and determines the brightness detection area in the rest of the images based on the brightness detection area of the reference image.

5. The image processing apparatus according to claim 1, wherein
the correction unit performs the brightness correction after applying a filter to blur each of or at least some of the plurality of images.

6. The image processing apparatus according to claim 1, further comprising:
a composition unit, wherein
the composition unit composites the plurality of images.

7. The image processing apparatus according to claim 6, wherein
the composition unit obtains contrast information from each of the plurality of images, and composites the plurality of images based on the contrast information.

8. An image capturing apparatus, comprising:
an image capturing unit configured to capture a plurality of images;
a calculation unit configured to calculate a coefficient of image magnification correction for correcting a difference in image magnification due to a difference in an in-focus position with respect to the plurality of images having different in-focus positions; and
a correction unit configured to perform brightness correction on at least some of the plurality of images, wherein,
the correction unit sets, for each of the plurality of images, a brightness detection area of a size corresponding to the coefficient of the image magnification correction, and performs the brightness correction based on a brightness value acquired in the brightness detection area set for each of the images.

9. The image capturing apparatus according to claim 8, wherein
the image capturing unit captures the plurality of images while changing the in-focus positions so that the image magnification becomes smaller.

10. A method of image processing, comprising:
calculating a coefficient of image magnification correction for correcting a difference in image magnification due to a difference in an in-focus position with respect to a plurality of images having different in-focus positions; and
performing brightness correction on at least some of the plurality of images, wherein
for each of the plurality of images, a brightness detection area of a size corresponding to the coefficient of the image magnification correction is set, and the brightness correction is performed based on a brightness value acquired in the brightness detection area set for each of the images.

11. A computer-readable storage medium for storing at least one program that causes at least one processor to execute a method of image processing, the method comprising:
calculating a coefficient of image magnification correction for correcting a difference in image magnification due to a difference in an in-focus position with respect to a plurality of images having different in-focus positions; and
performing brightness correction on at least some of the plurality of images, wherein
for each of the plurality of images, a brightness detection area of a size corresponding to the coefficient of the image magnification correction is set, and the brightness correction is performed based on a brightness value acquired in the brightness detection area set for each of the images.
